(19) United States
(12) Patent Application Publication
(10) Pub. No.: US 2008/0295020 A1
(43) Pub. Date: Nov. 27, 2008

(54) Appropriating User Interface Real Estate

(76) Inventors: Thomas R. Haynes, Apex, NC (US); Arun K. Janardhanan, Murugesh Palya (IN); Shubir Kapoor, Shrub Oak, NY (US); Rajesh K. Ravi, Tiruverumbur (IN)

Correspondence Address: LAW OFFICE OF JIM BOICE, 3839 BEE CAVE ROAD, SUITE 201, WEST LAKE HILLS, TX, 78746, US

(21) Appl. No.: 11/752,435

(22) Filed: May 23, 2007

(51) Int. Cl. G06F 3/048

(52) U.S. Cl. 715/781

(57) ABSTRACT

A computer-implementable method, system and computer media for allocating and managing insignificant areas of Graphical User Interface (GUI) real estate are presented. In a preferred embodiment, the computer-implementable method includes identifying an insignificant area of GUI real estate in a GUI that is used by a first application. The identified insignificant area of GUI real estate is then populated with a graphical element of a second application.

### BACKGROUND OF THE INVENTION

The present invention relates in general to the field of computers and other data processing systems, including hardware, software and processes. More particularly, the present invention pertains to appropriating and managing Graphical User Interface (GUI) real estate.

In a typical Graphical User Interface (GUI) desktop, the display area (“GUI real estate”) is usually occupied by application-specific windows, menus, a taskbar (that lets the user view and switch between the running operations) and other Operating System (OS) user interface elements. Since this desktop area is usually not large enough for all of the running applications to display their content at once, the OS allows the user to select a subset of applications to be hidden while they run in the background with their windows in minimized or hidden states. Most of the time, a single application occupies most of the display area, even though there are “insignificant” areas being displayed. That is, there are often areas in the application's GUI that are meaningless, such as large areas of monochromatic real estate that provide neither functionality nor information. Thus, such areas waste large areas of the GUI real estate.

### SUMMARY OF THE INVENTION

To address the condition described above, presently disclosed are a computer-implementable method, system and computer media for allocating and managing insignificant areas of Graphical User Interface (GUI) real estate. In a preferred embodiment, the computer-implementable method includes identifying an insignificant area of GUI real estate in a GUI that is used by a first application. The identified insignificant area of GUI real estate is then populated with a graphical element of a second application.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a first application's Graphical User Interface (GUI), which includes one or more insignificant areas of GUI real estate;

FIG. 2 illustrates a second application's GUI (shown for exemplary purposes as a task bar) populating an insignificant area of the first applications GUI real estate;

FIG. 3 depicts an accessory application (shown for exemplary purposes as a calculator), chosen from the task bar shown in FIG. 2, populating another insignificant area of the first application's GUI real estate;

FIG. 4 is a flow-chart of exemplary steps taken, preferably by a computer, to appropriate and manage insignificant GUI real estate; and

FIG. 5 depicts an exemplary computer in which the present invention may be implemented.

### DETAILED DESCRIPTION OF THE PREFERRED EMBODIMENT

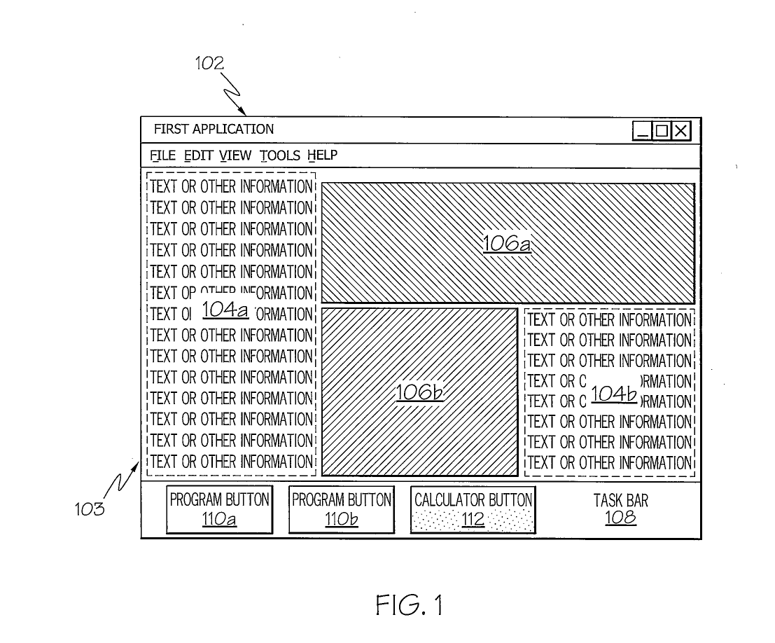

With reference now to the figures, and in particular to FIG. 1, a Graphical User Interface (GUI) 102 for a first application is shown. A main active window 103 for the first application includes significant real estate areas 104a and 104b. In the example shown, these areas are deemed significant because they contain text or other information. Alternatively, such areas may be deemed significant because they provide functionality, such as active areas (e.g., links to other windows, operational buttons, etc.). Significant real estate areas 104a-b may or may not be protected, such that other applications may or may not display information or active areas in the significant real estate areas.

The main active window 103 also includes insignificant real estate areas 106a and 106b. These insignificant real estate areas may be deemed insignificant because, as depicted, they are monochromatic, thus suggesting that they contain no text, graphics, or other information, and similarly contain no active areas (such as buttons, or links to webpages, other applications, etc.). Note that insignificant real estate area 106b may stop at, or lie under, insignificant real estate area 106a.

Also part of GUI 102 is a task bar 108, which includes program buttons 110a, 110b, and 112 for minimized programs. As suggested by the figure, program button 112 is for a calculator accessory application.

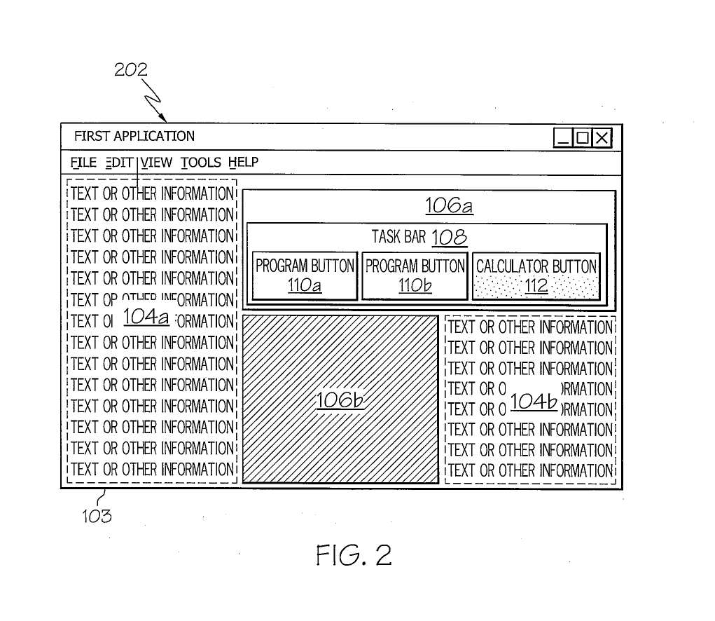

Referring now to FIG. 2, a GUI 202 is illustrated. GUI 202 is similar to GUI 102 shown in FIG. 1, except that the task bar 108 shown in FIG. 1, along with the program buttons 110a, 110b, and 112, has been moved into the insignificant real estate area 106a. That is, task bar 108 has appropriated, for its own use and display, insignificant real estate area 106a.

The identification of which real estate areas are significant and/or insignificant, as well as the appropriation of insignificant real estate areas, may be performed by an operating system of a computer that is displaying the GUI 102. This identification and appropriation is performed in accordance with pre-defined criteria. Such criteria include, but are not limited to, an area being monochromatic, unchanging, unused, or containing “junk” information, such as text or graphic information that has been heuristically identified as being unimportant to a user. This determination of whether a real estate area is significant and/or insignificant may alternatively be performed by an application, such as a first application that is currently occupying a GUI, a second application that will be appropriating the insignificant GUI real estate, or a third application that is dedicated to identifying significant/insignificant GUI real estate. Note that the main window 103 is now larger than when shown in FIG. 1, since the main window 103 has been able to take over (appropriate and utilize) the GUI real estate area previously used by the task bar 108.

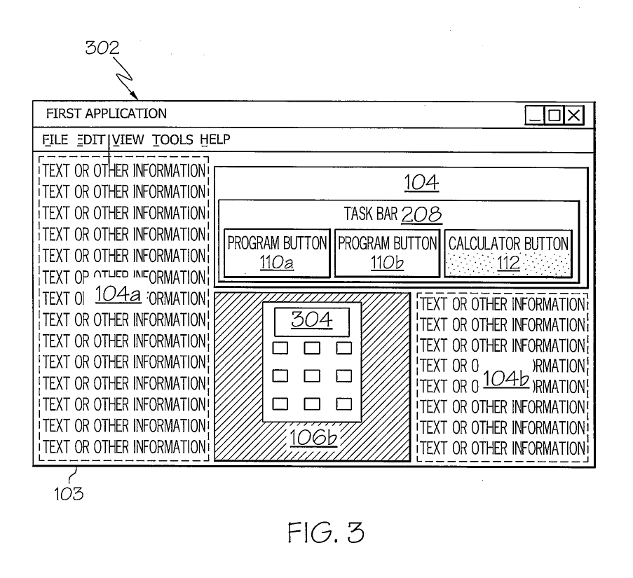

Referring now to FIG. 3, a GUI 302, which is similar to GUI 102 and GUI 202 described above, shows the consequences of clicking calculator button 112 (which alternatively, may have been presented in a drop-down program menu). Clicking calculator button 112 has resulted in a graphical element 304, which is associated with an underlying calculator program, being presented in the previously identified insignificant real estate area 106b. Thus, there is now no unused, and thus wasted, real estate area in the main window 103.

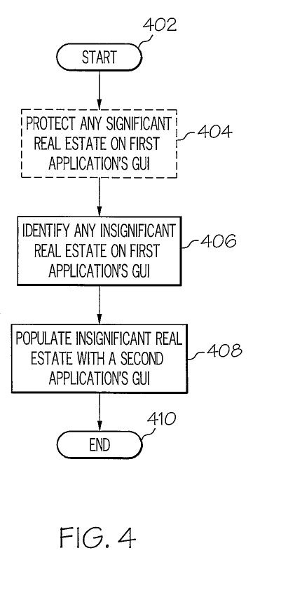

Referring now to FIG. 4, a flow-chart of exemplary steps taken in accordance with the present disclosure is presented. After initiator block 402, any significant real estate in a first application's GUI may optionally be protected (block 404). Protected real estate is GUI real estate that may not be appropriated by another GUI object. Whether the significant real estate is protected or not, insignificant real estate on the first application's GUI is then identified (block 406). As described above, insignificant real estate may be identified as real estate that is monochromatic (one color), and thus presents no text, graphics or functional elements. Alternatively, real estate may be deemed insignificant if there has been no activity (clicks, changes, etc.) after a predetermined dormant period of time. This identification may be performed by an OS, or by the first application, or by another application, including a second application that will be appropriating the insignificant real estate area for its own use. Alternatively, a user can, through the use of a mouse or similar pointer, manually “box” an area of GUI real estate that the user deems insignificant. The user can then click a control button (e.g., a command from a drop-down menu) to define the user-selected area as being insignificant.

If the identification of insignificant real estate is performed by an application, in a preferred embodiment an Application Program Interface (API) provided by the OS is used. That is, in one preferred embodiment, the application marks unused (insignificant) GUI real estate in the application's client space. The OS provides an API for the application to call. Whenever the client area (content displayed on the application's GUI) inside the application changes, the application calls the OS-provided API to re-register the unused GUI area. Thus, the application first determines that it wants to display a new GUI object. The application then calls the OS-provided system-level API, which includes the dimensions of the new GUI that the application wants to display. The OS then checks the graphics engine image map (pixel memory) and does a check to find the optimal location to suggest where the application should display the new GUI object (graphical element). The decision regarding where to display the new GUI object in the application's GUI may be based on Optical Character Recognition (OCR), such that the display of the new GUI object is based on the text information content found in a part of the application's GUI, which text information is deemed insignificant. Thus, if the text information in the application's GUI is insignificant, then the area in which this text information is displayed is likewise deemed insignificant. Alternatively, the location in the application's GUI for displaying the new GUI object may be based on monochromatic features, in which the entire identified area is the same color (e.g., grey), and thus conveys no textual or graphical information. Such monochromatic areas are also deemed “insignificant.”

In another embodiment, the OS can directly determine which GUI real estate is insignificant, in accordance with criteria described above. For example, the OS can automatically determine which geometric areas in the application's GUI are “insignificant.” This determination can be made periodically (according to some pre-determined time period), or can be made “on demand” whenever a new GUI object, including a GUI object from another application, needs to be displayed in GUI real estate previously owned by the first application's GUI.

Note that whether the OS or an application identifies an insignificant GUI real estate area, a pre-determined minimum size may be defined. That is, while examining the GUI real estate for insignificant areas, the OS or application may ignore areas that, although meet other criteria for “insignificance,” are physically too small to be useful to another GUI object.

After the insignificant real estate area is identified, the second application can then appropriate that area, and populate the appropriated area with a graphical element or elements that are associated with the second application (block 408), in a manner described above. In a preferred embodiment, the graphical element is automatically resized to fit within, or occupy all of, the previously insignificant real estate area. Alternatively, if the graphical element is too large, the graphical element can be displayed in the insignificant real estate and then overlap a portion of significant real estate area. If the graphical element has to overlap into significant real estate, then the portion that overlaps the significant real estate is preferably semi-transparent, such that the significant information originally displayed in the significant real estate area can still be seen (even if partially obscured.) Note that in one embodiment, the graphical element, of the second application, which is to populate the previously insignificant real estate area, may be an incoming element, such as a pop-up window that contains an incoming message to a user. The process ends at terminator block 410.

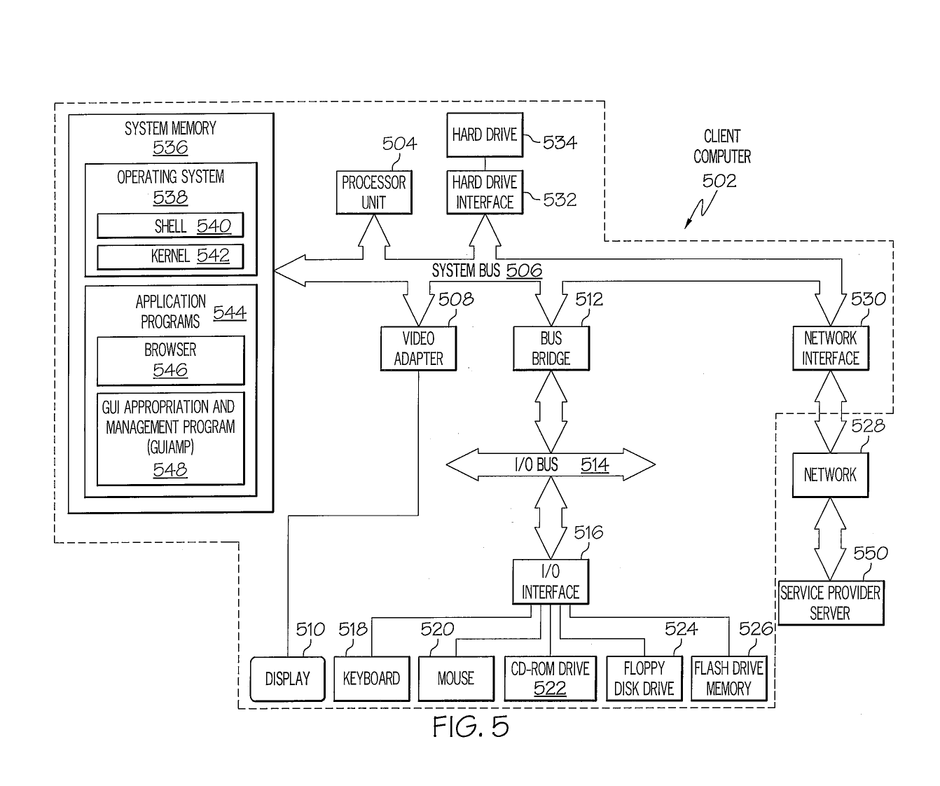

With reference now to FIG. 5, there is depicted a block diagram of an exemplary client computer 502, in which the present invention may be utilized. Client computer 502 includes a processor unit 504 that is coupled to a system bus 506. A video adapter 508, which drives/supports a display 510, on which GUI's described herein are displayed, is also coupled to system bus 506. System bus 506 is coupled via a bus bridge 512 to an Input/Output (I/O) bus 514. An I/O interface 516 is coupled to I/O bus 514. I/O interface 516 affords communication with various I/O devices, including a keyboard 518, a mouse 520, a Compact Disk-Read Only Memory (CD-ROM) drive 522, a floppy disk drive 524, and a flash drive memory 526. The format of the ports connected to I/O interface 516 may be any known to those skilled in the art of computer architecture, including but not limited to Universal Serial Bus (USB) ports.

Client computer 502 is able to communicate with a service provider server 550 via a network 528 using a network interface 530, which is coupled to system bus 506. Network 528 may be an external network such as the Internet, or an internal network such as an Ethernet or a Virtual Private Network (VPN).

A hard drive interface 532 is also coupled to system bus 506. Hard drive interface 532 interfaces with a hard drive 534. In a preferred embodiment, hard drive 534 populates a system memory 536, which is also coupled to system bus 506. System memory is defined as a lowest level of volatile memory in client computer 502. This volatile memory may include additional higher levels of volatile memory (not shown), including but not limited to cache memory, registers, and buffers. Data that populates system memory 536 includes client computer 502's operating system (OS) 538 and application programs 544.

OS 538 includes a shell 540, for providing transparent user access to resources such as application programs 544. Generally, shell 540 is a program that provides an interpreter and an interface between the user and the operating system. More specifically, shell 540 executes commands that are entered into a command line user interface or from a file. Thus, shell 540 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 542) for processing. Note that while shell 540 is a text-based, line-oriented user interface, the present invention will equally well support other user interface modes, such as graphical, voice, gestural, etc.

As depicted, OS 538 also includes kernel 542, which includes lower levels of functionality for OS 538, including providing essential services required by other parts of OS 538 and application programs 544, including memory management, process and task management, disk management, and mouse and keyboard management.

Application programs 544 include a browser 546. Browser 546 includes program modules and instructions enabling a World Wide Web (WWW) client (i.e., client computer 502) to send and receive network messages to the Internet using HyperText Transfer Protocol (HTTP) messaging, thus enabling communication with service provider server 550.

Application programs 544 in client computer 502's system memory also include a Graphical User Interface Appropriation and Management Program (GUIAMP) 548, which includes code for implementing the processes and Graphical User Interfaces (GUIs) described in FIGS. 1-4. Note that GULAMP 548 includes code for detecting mouse clicks, cursor positioning, and other program and GUI monitoring to determine when a second application's GUI should populate insignificant real estate on a first application's GUI, in accordance with the process described above.

In one embodiment, client computer 502 is able to download GUIAMP 548 from service provider server 550, preferably in an “on demand” basis.

Note that the hardware architecture for service provider server 550 may be substantially similar to that shown for client computer 502.

The hardware elements depicted in client computer 502 are not intended to be exhaustive, but rather are representative to highlight essential components required by the present invention. For instance, client computer 502 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 550 performs all of the functions associated with the present invention (including execution of GUIAMP 548), thus freeing client computer 502 from using its own resources.

It should be understood that at least some aspects of the present invention may alternatively be implemented in a computer-useable medium that contains a program product. Programs defining functions of the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of GUIAMP 548, are performed by service provider server 550. Alternatively, GUIAMP 548 can be deployed as software from service provider server 550 to client computer 502. This deployment may be performed in an “on demand” basis manner, in which GUIAMP 548 is only deployed when needed by client computer 502. In another embodiment, process software for the method so described may be deployed to service provider server 550 by another service provider server (not shown).

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method for optimizing usage of real estate in a Graphical User Interface (GUI), the computer-implementable method comprising:
identifying an insignificant area of GUI real estate in a GUI that is used by a first application; and
populating an identified insignificant area of GUI real estate with a graphical element from a second application.

2. The computer-implementable method of claim 1, wherein the insignificant area of GUI real estate is identified by an operating system.

3. The computer-implementable method of claim 1, wherein the insignificant area of GUI real estate is identified by the first application.

4. The computer-implementable method of claim 1, wherein the insignificant area of GUI real estate is identified by the second application.

5. The computer-implementable method of claim 1, wherein the graphical element of the second application is a pop-up window of an incoming user message.

6. The computer-implementable method of claim 1, further comprising:
categorizing any monochromatic area of GUI real estate as being the insignificant area of GUI real estate.

7. The computer-implementable method of claim 1, further comprising:
defining a pre-determined period of time as a dormant time period; and
categorizing any area of GUI that is not activated after the dormant time period has expired as being the insignificant area of GUI real estate.

8. The computer-implementable method of claim 1, further comprising:
automatically resizing the graphical element of the second application to fit within the identified insignificant area of GUI real estate.

9. The computer-implementable method of claim 1, wherein the second application is a task bar that displays program buttons for minimized running operations, and wherein the computer-implementable method further comprises:
moving the task bar from an edge of the GUI to the identified insignificant area of GUI real estate.

10. The computer-implementable method of claim 1, wherein the insignificant area of GUI real estate is identified by a user, and wherein the computer-implementable method further comprises:
receiving, from a user, an input that identifies the insignificant area of GUI real estate.

11. The computer-implementable method of claim 1, further comprising:
identifying protected regions of the real estate of the GUI; and
blocking any appropriation of the protected regions for use by the second application.

12. A system comprising:
a processor;
a data bus coupled to the processor;
a memory coupled to the data bus; and
a computer-usable medium embodying computer program code, the computer program code comprising instructions executable by the processor and configured for optimizing usage of real estate in a Graphical User Interface (GUI) by performing the steps of:
identifying an insignificant area of GUI real estate in a GUI for a first application; and
populating an identified insignificant area of GUI real estate with a graphical element of a second application.

13. The system of claim 12, wherein the insignificant area of GUI real estate is identified by an operating system.

14. The system of claim 12, wherein the instructions are further configured for:
automatically resizing the graphical element of the second application to fit within the identified insignificant area of GUI real estate.

15. The system of claim 12, wherein the insignificant area of GUI real estate is identified by a user, and wherein the instructions are further configured for:
receiving, from a user, an input that identifies the insignificant area of GUI real estate.

16. The system of claim 12, wherein the instructions are further configured for:
identifying protected regions of the real estate of the GUI; and
blocking any appropriation of the protected regions for use by the second application.

17. A computer-readable medium encoded with a computer program, the computer program comprising computer executable instructions configured for:
identifying an insignificant area of Graphical User Interface (GUI) real estate in a GUI for a first application; and
populating an identified insignificant area of GUI real estate with a graphical element of a second application.

18. The computer-readable medium of claim 17, wherein the computer executable instructions are further configured for
identifying protected regions of the real estate of the GUI; and
blocking any appropriation of the protected regions for use by the second application.

19. The computer-readable medium of claim 17, wherein the computer-usable medium is a component of a remote server, and wherein the computer executable instructions are deployable to a supervisory computer from the remote server.

20. The computer-readable medium of claim 17, wherein the computer executable instructions are capable of being provided by a service provider to a customer on an on-demand basis.
